(19) United States
(12) Patent Application Publication
(10) Pub. No.: US 2026/0183177 A1
(43) Pub. Date: Jul. 2, 2026

(54) Sucking Structure

(71) Applicant: Tian

(72) Inventor: Mengxu Cao, Tanghe County (CN)

(21) Appl. No.: 19/002,660

(22) Filed: Dec. 26, 2024

(51) Int. Cl. A61H 9/00; A61H 19/00

(52) U.S. Cl. CPC A61H 9/0057; A61H 19/30; A61H 2201/1215

(57) ABSTRACT

A sucking structure includes a motor, a bracket fixedly installed on the upper of the motor, a positioning shell is fixedly installed on the top of the bracket, a rotating shaft is rotatably installed inside the positioning shell, a cam groove is provided on the outer end of the rotating shaft, a fixing block is slidably installed on the top of the bracket, a ball provided in the cam groove is rotatably installed on the fixing block, a piston assembly is sleeved on the outer side of the positioning shell, a cavity shell sleeved on the outer side of the piston assembly is fixedly installed on the bracket, and a sucking opening is provided on the top end of the cavity shell.

### FIELD OF THE INVENTION

The invention relates to the technical field of adult toys, in particular to a sucking structure.

### BACKGROUND OF THE INVENTION

Adult toys are generally used to stimulate human sexual organsor provide the touch feelings similar to that of human sexual organs. In addition, there are also sexual toys such as some ornaments or small toys with sexual connotations, for example, vibrators are used to apply stimulation to specific areas of the skin through direct contact.

In order to stimulate sensitive areas, traditional vacuum devices are usually used in the prior art, typically using manual pumps, the operation of which is cumbersome or annoying. In addition, long-term or uninterrupted application of negative pressure may also lead to a habituation effect, thereby limiting the long-term effectiveness of the device.

Therefore, the present invention provides a suction structure to solve the above problems.

### SUMMARY OF THE DISCLOSURE

The present invention provides a sucking structure, which effectively solves the problem that the manual operation of the existing pump is annoying.

To achieve the above object, the present invention provides the following technical solutions:

A sucking structure comprises a motor, a bracket is fixedly installed on the upper of the motor, a positioning shell is fixedly installed on the top of the bracket, a rotating shaft is rotatably installed inside the positioning shell, a cam groove is provided on the outer end of the rotating shaft, a fixing block is slidably installed on the top of the bracket, a ball provided in the cam groove is rotatably installed on the fixing block, a piston assembly is sleeved on the outer side of the positioning shell, a cavity shell sleeved on the outer side of the piston assembly is fixedly installed on the bracket, and a sucking opening is provided on the top of the cavity shell.

Preferably, the piston assembly includes a piston shell, a limiting strip is fixedly installed inside the piston shell, a limiting groove is provided on the outer end of the positioning shell, the limiting strip slides up and down and is slidably installed in the limiting groove, a guide hole is provided on the positioning shell, the fixing block slides up and down and is slidably installed in the guide hole, and the top end of the fixing block is fixedly installed on the piston shell.

Preferably, a sealing gasket is fixedly installed on the outer side of the upper of the piston shell.

Preferably, the cavity shell and the bracket are connected by screws.

Preferably, a plane shaft is installed on the rotating shaft of the motor, an insert hole is provided at the bottom end of the rotating shaft, the plane shaft slides up and down and is slidably installed in the insert hole.

The beneficial effects of the present invention are:
The reciprocating motion of the sealing gasket in the gas cavity will achieve the function of gas leakage and internal suction, thereby improving the satisfaction of user.

The present invention has the advantages of simple structure, convenient and safe use, and significant stimulation effect.

### BRIEF DESCRIPTION OF THE DRAWINGS

FIG. 1 is a perspective view of the present invention.

FIG. 2 is a cross-sectional perspective view of FIG. 1 of the present invention.

FIG. 3 is a schematic structural view of the piston shell of the present invention.

FIG. 4 is a schematic structural view of the positioning shell of the present invention.

FIG. 5 is a schematic structural view of the rotating shaft of the present invention.

FIG. 6 is a cross-section perspective view of the rotating shaft of the present invention.

FIG. 7 is an exploded perspective view of the present invention.

### DETAILED DESCRIPTION OF THE PREFERRED EMBODIMENTS

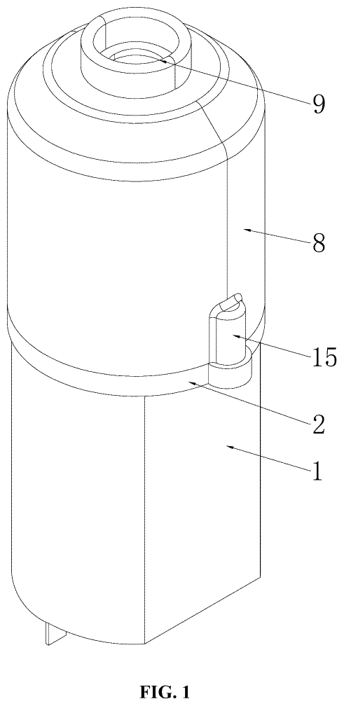

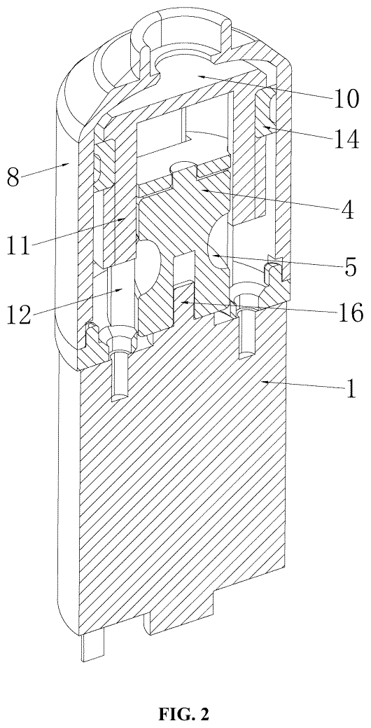

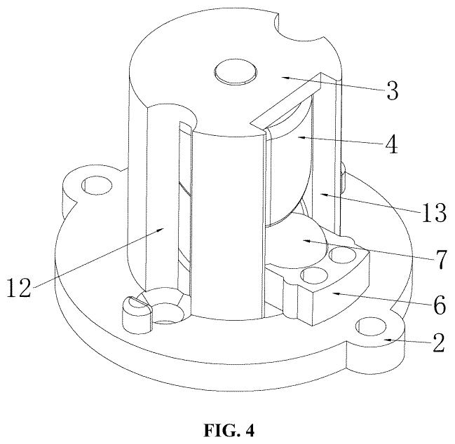

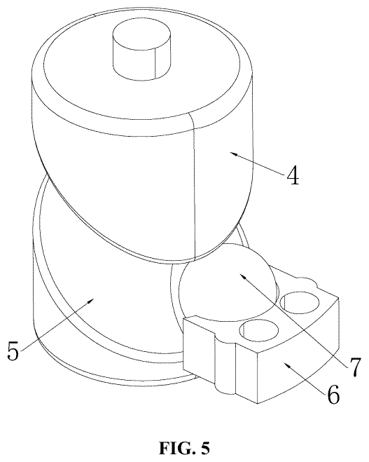

Other features, objects and advantages of the present invention will be more clearly and completely by the detailed description of the non-limiting embodiments with reference to the attached drawings (FIG. 1 to FIG. 7). Obviously, the described embodiments are only part of the embodiments of the present invention, but not all of them. Based on the embodiments of the present invention, all other embodiments obtained by ordinary technicians in the field without creative labor are within the scope of the present invention.

A sucking structure, as shown in FIGS. 1 to 5, includes a motor 1, a bracket 2 is fixedly installed on the upper of the motor 1, a positioning shell 3 is fixedly installed on the top of the bracket 2, the bracket 2 and the positioning shell 3 are provided in a through manner, a rotating shaft 4 is coaxially rotatably installed inside the positioning shell 3, a cam groove 5 is provided on the outer end of the rotating shaft 4, one side of the cam groove 5 is high and the other side is low, the top of bracket 2 is equipped with a fixing block 6 that slides up and down on one side of the rotating shaft 4, a ball 7 provided in the cam groove 5 is rotatably installed on the inner end of the fixing block 6, the outer side of the positioning shell 3 is sleeved with a piston assembly, a cavity shell 8 sleeved on the outer side of the piston assembly is fixedly installed on the bracket 2, and a sucking opening 9 is provided on the top of the cavity shell 8.

As shown in FIGS. 1, 2 and 4, the piston assembly includes a piston shell 10, a limiting strip 11 is fixedly installed on the inner wall of the piston shell 10, a limiting groove 12 is provided on the outer end of the positioning shell 3, the limiting strip 11 is slidably installed in the limiting groove 12, a guide hole 13 is provided on the positioning shell 3, the fixing block 6 is slidably installed in the guide hole 13, and the top end of the fixing block 6 is fixedly installed on the bottom end of the piston shell 10.

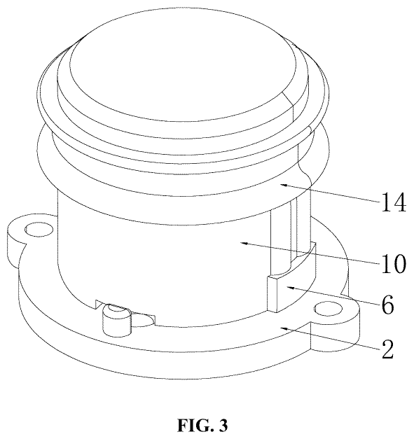

As shown in FIG. 3, the cavity shell 8 is sleeved on the outer side of the piston shell 10, and a gas cavity is reserved between the inner wall of the cavity shell 8 and the outer wall of the piston shell 10. A sealing gasket 14 is fixedly installed on the outer side of the upper of the piston shell 10, and the sealing gasket 14 is provided in the gas cavity.

As shown in FIG. 1, the cavity shell 8 and the bracket 2 are fixedly connected by screws 15.

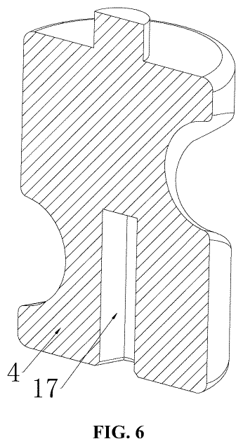

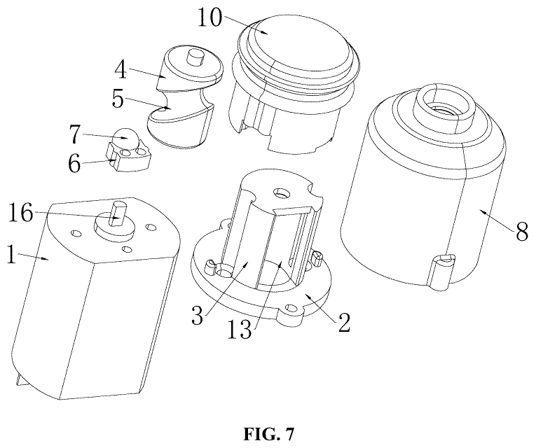

As shown in FIGS. 6 and 7, a plane shaft 16 is coaxially fixedly installed on the rotating shaft of the motor 1, and an axis plane is provided on the outer side of the plane shaft 16. An insert hole 17 is provided at the bottom end of the rotating shaft 4, and a hole plane is provided in the insert hole 17. The plane shaft 16 is installed in the insert hole 17, and the axis plane fits with the hole plane, so that when the plane shaft 16 rotates with the rotating shaft 4, the plane shaft 16 can also slide up and down in the insert hole 17.

The working principle of the present invention:
Firstly, fix the motor 1 on the toy, put the sucking opening 9 on the human organs, turn on the power supply and the controller, the plane shaft 16 and the rotating shaft 4 rotates with the motor 1. Due to the limiting strip 11 is installed in the limiting groove 12, the ball 7 can only move upward along the cam groove 5, and the piston shell 10 moves upward with the sealing gasket 14 synchronously, and the sealing gasket 14 can leak the gas in the gas cavity outward through the sucking opening 9. when the ball 7 moves to the highest end of the cam groove 5, the ball 7 gradually moves along the cam groove 5 to the lowest end, the piston shell 10 moves downward with the sealing gasket 14 synchronously. Due to the downward movement of the sealing gasket 14, negative pressure is generated inside the gas cavity, thereby generating suction on the human organs. Through the rapid rotation of the motor 1, the sealing gasket 14 reciprocates in the gas cavity, which will achieve the function of gas leakage and internal suction, thereby improving the satisfaction of the user. The device has the advantages of simple structure, easy use, safety, and significant stimulation effect.

In the present invention, the use of orientation words such as “top”, “bottom”, “outer”, “inner” are only for the convenience of description, rather than indicating or implying the specific orientation, therefore it should not be construed as being limited to the description of the following embodiments.

Unless otherwise stated, it should be noted that the terms “installed” and “connected” should be understood broadly. For example, “connected” could be fixed connection, detachable connection, integral connection, mechanical connection, electrical connection, direct connection, indirect connection through the intermediate structure, or internal connection between two elements. For those of ordinary skill in this field, the specific meanings of the above terms in the present invention can be understood in specific situations.

In the present invention, the terms “includes/comprises” and the like in the description and claims of the present invention are used to describe the technical features, numerical values, steps or components. One or more other features, numerical values, steps, components or their combinations based on this invention shall be included in the scope of protection of the present invention. It is to be understood that the data so used are interchangeable under appropriate circumstances in order to describe the embodiments of the invention herein.

Hereinafter, embodiments of the present invention have been described in detail with reference to the accompanying drawings. While the description above refers to the particular embodiments of the present invention, it will be understood that many modifications may be made without departing from the spirit thereof. Any equivalent replacement or modification would fall within the protection scope of the present invention.

What is claimed is:

1. A sucking structure comprising a motor (1), a bracket (2) fixedly installed on the upper of the motor (1), a positioning shell (3) is fixedly installed on the top of the bracket (2), a rotating shaft (4) is rotatably installed inside the positioning shell (3), a cam groove (5) is provided on the outer end of the rotating shaft (4), a fixing block (6) is slidably installed on the top of the bracket (2), a ball (7) provided in the cam groove (5) is rotatably installed on the fixing block (6), a piston assembly is sleeved on the outer side of the positioning shell (3), a cavity shell (8) sleeved on the outer side of the piston assembly is fixedly installed on the bracket (2), and a sucking opening (9) is provided on the top of the cavity shell (8).

2. The sucking structure according to claim 1, wherein the piston assembly includes a piston shell (10), a limiting strip (11) is fixedly installed inside the piston shell (10), a limiting groove (12) is provided on the outer end of the positioning shell (3), the limiting strip (11) slides up and down and is slidably installed in the limiting groove (12), a guide hole (13) is provided on the positioning shell (3), the fixing block (6) slides up and down and is slidably installed in the guide hole (13), and the top end of the fixing block (6) is fixedly installed on the piston shell (10).

3. The sucking structure according to claim 2, wherein a sealing gasket (14) is fixedly installed on the outer side of the upper of the piston shell (10).

4. The sucking structure according to claim 1, wherein the cavity shell (8) and the bracket (2) are connected by screws (15).

5. The sucking structure according to claim 1, wherein a plane shaft (16) is installed on the rotating shaft of the motor (1), an insert hole (17) is provided at the bottom end of the rotating shaft (4), the plane shaft (16) slides up and down and is slidably installed in the insert hole (17).
